(19) United States
(12) Patent Application Publication
(10) Pub. No.: US 2008/0135492 A1
(43) Pub. Date: Jun. 12, 2008

(54) TANNIN BASED POLYMERIC COAGULANTS AND THEIR USE IN WASTE WATER CLARIFICATION

(76) Inventors: Ashok Shyadligeri, Bangalore (IN); Narain Madhavan, Bangalore (IN)

Correspondence Address: GENERAL ELECTRIC CO.;GLOBAL PATENT OPERATION, 187 Danbury Road, Suite 204, Wilton, CT, 06897-4122, US

(21) Appl. No.: 11/608,256

(22) Filed: Dec. 8, 2006

(51) Int. Cl. C02F 1/56

(52) U.S. Cl. 210/735; 210/730

(57) ABSTRACT

Tannin based environmentally friendly polymeric coagulants are disclosed which are copolymers of naturally occurring tannins, dialdehyde and diamines. In a preferred embodiment, the dialdehyde is glyoxal and the diamine is dimethylamino propylamine.

### FIELD OF THE INVENTION

The present invention relates to a process of clarifying wastewater, and in particular the oily waste water from the production of pharmaceuticals, food and beverages. More particularly, this invention relates to the process for the production of tannin based polymeric coagulants and their use for the clarification of oily wastewater.

### BACKGROUND OF THE INVENTION

Water clarification is well known through out a number of industries. Various physical means have been used to remove particulate matter dispersed in a bulk liquid phase. Examples of common particulate separation techniques include filtration, settling, desalting, electrostatic precipitation, centrifugation, flotation and the like. Such separation processes can often be made more efficient by the use of coagulating and flocculating agents. Wastewater containing emulsified oil can be difficult and inefficient to resolve by physical processes alone. In such circumstances, chemical agents can be used to break the emulsion, and once broken, coagulants and flocculants can be used to hasten agglomeration of the oil particles formed. Inorganic coagulants alone or in combination with organic polyelectrolytes have been used in demulsification. However, these treatments are not completely satisfactory because they increase solids content, which can cause waste stream disposal problems.

Tannins are astringent water-soluble extracts from the bark, pods, leaves, and fruit of various plants and trees. Established industrial practices of extracting tannins from the wood of the quebracho tree and the bark of the wattle tree have made condensed tannins available in substantial quantities. Condensed tannins are polyphenolic and polymerize in combination with other chemicals such as formaldehyde.

U.S. Pat. No. 4,558,080 discloses the production of stable tannin-based flocculants made by polymerizing tannin with an aldehyde such as formaldehyde and an amino compound, such as monoethanolamine, while monitoring the viscosity of the reacting mixture.

U.S. Pat. No. 4,734,216, discloses a flocculating compound comprising the polymerized tannin described in the above referenced patent in combination with an inorganic flocculent such as aluminum sulfate or iron chloride.

U.S. Pat. No. 5,643,462 discloses a composition comprised of a water soluble/dispersible tannin containing polymer obtained by polymerizing ethylenically unsaturated monomers with tannin, the method of preparing the same and their use for water clarification.

U.S. Pat. No. 6,478,986 teaches a process for the production of a quaternary tannate as a coagulating/flocculating agent, and its use for treating drinking water and water used in industry. The coagulating/flocculating agent is a vegetable polyelectrolytic cation.

There still remains a need for a simple preparation of tannin based environmentally friendly polymeric coagulants, which are useful in water clarification processes.

### SUMMARY OF THE INVENTION

Tannin based environmentally friendly polymeric coagulants are disclosed which are copolymers of naturally occurring tannins, dialdehydes and diamines.

### DETAILED DESCRIPTION OF THE INVENTION

The singular forms “a,” “an” and “the” include plural referents unless the context clearly dictates otherwise. The endpoints of all ranges reciting the same characteristic are independently combinable and inclusive of the recited endpoint. All references are incorporated herein by reference

The modifier “about” used in connection with a quantity is inclusive of the stated value and has the meaning dictated by the context (e.g., includes the degree of error associated with measurement of the particular quantity).

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

Presently is disclosed a “one pot” preparation of environmentally friendly polymeric coagulants that are tannin based, more specifically, naturally occurring tannins, which are reacted with a cationic polymer and their use for the clarification of oil containing waste water.

The tannin component can be obtained from various wood and vegetation materials found throughout the world. Tannins are a large group of water-soluble complex organic compounds. Almost every tree or shrub that grows contains some tannins in the leaves, twigs, barks, wood or fruit. Examples of barks are wattle, mangrove, oak, eucalyptus, hemlock, pine, larch and willow. Examples of woods are the quebracho chestnut, oak and urunday. Examples of fruits are myrobalans, valonia, divi-divi, tara and algarrobilla. Examples of leaves are sumac and gambier and examples of roots are canaigre and palmetto. Among the preferred materials is wattle. These natural tannins can be categorized into the traditional “hydrolysable” tannins and “condensed” tannins. Condensed tannin extracts are those manufactured from the bark of the black wattle tree, from the wood of the quebracho tree, from the bark of the hemlock tree and from the bark of several commonly used pine species. The preparation of the wattle and quebracho extracts is a well established industrial practice and they are freely available in considerable amounts.

Condensed tannin extracts, such as wattle and quebracho, are composed of approximately 70% polyphenolic tannins, 20% to 25% non-tannins, mainly simple sugars and polymeric carbohydrates (hydrocolloid gums) the latter of which constitute 3% to 6% of the extract and heavily contribute to extract viscosity, while the balance is accounted for by a low percentage of moisture. A preferred embodiment of the present invention calls for use of condensed tannin extracts.

One embodiment of the present invention comprises the preparation of a tannin based polymeric composition by reacting a tannin, a dialdehyde and a diamine. The synthesis preferably takes place in an aqueous medium and under acidic conditions. In particular, the synthesis should take place at a pH of less than or equal to about 7. This is accomplished by ensuring that an acid is charged into the reactor during the synthesis. A preferred acid is one that a strong acid and dissociates fully in solution. A good example, and a preferred acid is hydrochloric acid, but other acids with similar properties may also be used.

Aldehydes are organic compounds that contain a terminal carbonyl group. In an embodiment of the present invention, it is a dialdehyde that is used in connection with the synthesis of the tannin, and the preferred embodiment is the use of glyoxal, otherwise known as ethanedial, as the dialdehyde. Glyoxal, CHOCHO, is the smallest aliphatic dialdehydes, and is a low melting-point yellow crystalline solid, with a melting point of 15° C. Glyoxal is made by the catalytic oxidation of ethanediol.

The other component necessary for the successful synthesis of the tannin is a diamine, which is a polyamine with exactly two amino groups. Diamines include cadaverine, ethambutol, phenylenediamine, dimethylamino propylamine and ethylene diamine. In a preferred embodiment, the diamine is dimethylamino propylamine

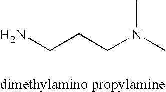

In a preferred embodiment, the tannin is synthesized in an aqueous medium, preferably in the presence of deionized water, at a temperature of about 60 to about 100° C., preferably from about 80 to about 90° C. The molar ratio of dialdehyde to diamine to a tannin repeating unit is from about 3:5:1 to about 5:2:1, with the preferred ratio of about 1.35:2.7:1. The use of a dialdehye and diamine combination versus other aldehydes and amines is the stability of the product produced. For instance the use of formaldehyde and ethanolamine would result in a less stable, and therefore less desirable product.

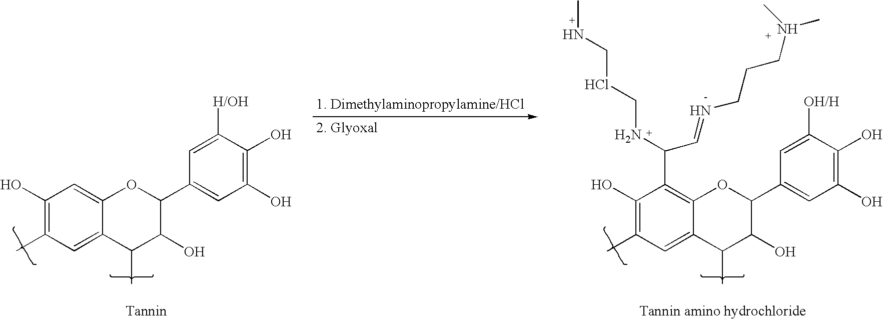

The resulting coagulants are able to be used for clarification of various waste water products, for instance they can be used to treat wastewater in the food and beverage industries, oil refineries and steel industry. Actual dosage ranges for the polymeric coagulants depend upon the characteristics of the wastewater to be treated. These characteristics include, for example, the amount of oil, the type of oil in the wastewater, the presence and concentration of other contaminants in the water, the amount of soluble metal ions present, and the pH of the water. Preferably, about 5 parts per million to about 10 parts per million of the polymeric coagulant to parts of the wastewater is employed. However, activity can be seen over broader doses of the coagulant, and certainly the composition of the actual wastewater to be treated will have a direct impact on the optimum dosage range. The tannin-based polymeric coagulant can be added to the wastewater neat, or in any suitable solvent such as water. These compounds can also be used in conjunction with additional flocculents to improve the treatment of wastewater. The preferred pH of the water is between about 6.5 to about 7.5 pH, and can be adjusted by the addition of a suitable acid or base.

The resulting floc can be removed by any conventional means such as dissolved air flotation or induced air flotation. In order to more clearly illustrate this invention, the data set forth below were developed. The following examples are included as being illustrations of the invention and should not be construed as limiting the scope thereof.

### EXAMPLE 1

### Preparation of Tannin Coagulant Composition

A tannin-based polymeric coagulant was prepared by charging a clean and dry reactor with 58.0 gms of deionized water (“DI”). The agitator was started and a nitrogen blanket was initiated around the reactor. The reactor was charged with 40.35 gms of 0.39 molar 3-dimethylaminopropylamine(99.0%). The reactor was then charged with 73.86 gms of 0.70molar hydrochloric acid, initial concentration 35%. The composition was equilibrated to about 38±2° C. At this point, the nitrogen blanket was discontinued. Over the next 5 to about 10 minutes, 62.50 gms of ME Wattle Tannin at 70% was added to the reactor, and the nitrogen blanket was then resumed. The batch was equilibrated to 50±2° C. and mixed until homogenous, which was for a period of about 30 minutes. 28.0 gms of 40%hlyoxal was charged over a period of about 30 minutes. It was charged via a syringe pump, and the temperature was maintained at about 30 to about 38° C. during the charging. The batch was then heated to about 88° C. over a 30 minute period. The batch was held a temperature of from about 88 to about 92° C. for a period of about 60 minutes. Immediately thereafter, the batch was begun to be cooled to room temperature. During the cool down, 30.0 gms of deionized water and 8 gms of 35% HCl were added to quench the reaction during the cool down. The DI water was charged after the acid addition. The resulting composition was mixed for 15 minutes and a sample taken to determine weight percent solids. The batch is then adjusted to a theoretical 40.0% solids with DI water as necessary. The target is from about 39.0 to about 41.0% solids with an actual measured amount for this batch at 40.18%. The yield for this example was >98%.

### EXAMPLE 2

A synthetic oily water mixture was prepared consisting of 75% vegetable fat, 11.8% POE4 Lauryl alcohol and 13.2% oleic acid. The mixture was mixed on a hot plate for 15 minutes and then was blended in a blender for an additional 10 minutes. 10 gms of this oily mixture was taken in a blender and blended for 7 minutes with 390 gms of distilled water. The resulting emulsion was diluted to 1:9 using tap water. The final synthetic oily water contained 0.20% fat and oil.

The resulting wastewater was added to six jars, 300 ml. each and placed in a six-paddle stirrer. The coagulant was added at 100 rpm and maintained at that speed for 2 minutes. The speed was lowered to 35 rpm, and maintained for an additional 10 minutes. The speed was then decreased to 0 rpm, and after about 30 minutes, a sample of the treated wastewater was taken from the bottom of the jar. The turbidity of the sample was noted and compared to the turbidity of the blank where no coagulant was added. The effectiveness was calculated and tabulated as a % reduction of turbidity.

TABLE 1
Efficacy testing results of Tannin based coagulant composition.

| Dosage | 756-119 | |
|---|---|---|
| ppm | NTU | % reduction |
| 400 | 1835.00 | 52.70 |
| 420 | 1278.00 | 67.06 |
| 440 | 274.00 | 92.94 |
| 480 | 160.86 | 95.85 |
| 500 | 159.00 | 95.90 |
| 600 | 42.93 | 98.89 |
| 720 | 40.63 | 98.95 |
| 800 | 40.43 | 98.96 |

While typical embodiments have been set forth for the purpose of illustration, the foregoing descriptions should not be deemed to be a limitation on the scope herein. It is apparent that numerous other forms and modifications of this invention will occur to one skilled in the art without departing from the spirit and scope herein. The appended claims and these embodiments should be construed to cover all such obvious forms and modifications that are within the true spirit and scope of the present invention

Having described the Invention, that which is claimed is:

1. A polymeric coagulant for use in wastewater clarification comprising tannin, dialdehyde and diamine.

2. The polymeric coagulant of claim 1 wherein the tannin is a condensed tannin.

3. The polymeric coagulant of claim 1 wherein the dialdehyde is chosen from the group consisting of cadaverine, ethambutol, phenylenediamine, dimethylamino propylamine and ethylene diamine.

4. The polymeric coagulant of claim 3 wherein the dialdehyde is dimethylamino propylamine.

5. The polymeric coagulant of claim wherein the diamine is glyoxal.

6. The polymeric coagulant of claim 1 wherein the molar ratio of of dialdehyde to diamine to a tannin repeating unit is from about 3:5:1 to about 5:2:1.

7. The polymeric coagulant of claim 6 of dialdehyde to diamine to a tannin repeating unit is about 1.35:2.7:1.

8. A method for forming a tannin based polymeric coagulant comprising reacting tannin with dialdehyde and diamine to form a polymeric coagulant.

9. The method of claim 8, wherein the reaction takes place in an aqueous medium.

10. The method of claim 8 wherein the reaction is carried out under acidic conditions.

11. The method of claim 8 wherein the reaction is carried out at a temperature of from about 80 to about 90° C.

12. A method for forming a tannin based polymeric coagulant comprising the steps of reacting tannin with dimethylamino propylamine and glyoxal in an aqueous medium to form a polymeric coagulant, in an aqueous medium under acidic conditions.

13. The polymeric coagulant produced by the method of claim 12.

14. In a process for process for treating wastewater by the addition of a coagulant, the improvement wherein the coagulant is the polymeric coagulant of claim 13.
